(19) United States
(12) Patent Application Publication
(10) Pub. No.: US 2009/0295500 A1
(43) Pub. Date: Dec. 3, 2009

(54) RADIO FREQUENCY POWER SPLITTER/COMBINER, AND METHOD OF MAKING SAME

(76) Inventor: Fred H. Ives, Veradale, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/130,686

(22) Filed: May 30, 2008

(51) Int. Cl. H01P 5/12

(52) U.S. Cl. 333/128; 29/846

(57) ABSTRACT

A radio frequency power splitter/combiner employs a multilayer printed circuit board (PCB). A first power splitter/combiner section is formed on a first layer of the multilayer PCB and has signal propagation traces coupling a first major port to a first pair of minor ports. A second power splitter/combiner section is formed on a second layer of the multilayer PCB and has signal propagation traces coupling a second major port to a second pair of minor ports. At least one signal ground is formed on one or more layers of the multilayer PCB intermediate the first layer and the second layer. The at least one signal ground isolates the first power splitter/combiner section from the second power splitter/combiner section.

### BACKGROUND

It is often necessary to split or combine radio frequency (RF) signals. One application where this is necessary is in the test of a mobile device under test (DUT) such as a mobile telephone. In this application, one or more RF power splitter/combiners may be used to connect the RF source and the RF measurement ports of a mobile communications test set to the antenna port of a DUT, thereby making connection to both the transmitter and the receiver of the DUT.

As used herein, an RF signal is any signal comprised of coherent electromagnetic radiation, which coherent electromagnetic radiation is usable for communication purposes.

As also used herein, an RF power splitter/combiner is a passive circuit that has a major port and two or more minor ports interconnected such that RF power applied to the major port is apportioned into (usually equal) amounts that are then available at the minor ports (assuming that they are properly terminated). Conversely, power applied to the minor ports is summed and made available as a combined amount at the major port.

One exemplary RF power splitter/combiner is disclosed in U.S. Pat. No. 5,668,510, entitled “Four Way RF Power Splitter/Combiner”. This splitter/combiner is built using coax cable, ferrite cores, and coupled-wire technology.

### BRIEF DESCRIPTION OF THE DRAWINGS

Illustrative embodiments of the invention are illustrated in the drawings, in which:

FIG. 1 illustrates an exemplary RF power splitter/combiner formed on a multilayer printed circuit board (PCB), wherein the thickness of the multilayer PCB is exaggerated for ease of understanding;

FIG. 2 provides a schematic of an RF power splitter/combiner having first, second and third splitter/combiner sections, as may be implemented on the multilayer PCB shown in FIG. 1;

FIG. 3 illustrates exemplary portions of first and second layer artwork for the multilayer PCB shown in FIG. 1, when the multilayer PCB is used to implement the Wilkinson divider sections shown in FIG. 2;

FIG. 4 illustrates, in cross-section, an exemplary exploded view of the multilayer PCB shown in FIG. 1; and

FIG. 5 an exemplary method of forming an RF power splitter/combiner.

### DETAILED DESCRIPTION

Over the past several years, the RF connectivity of mobile telephones has moved from 800-900 MHz to 1800-1950 MHz and beyond. New frequency bands have been assigned, and old bands have been reassigned, so that connectivity from 380-2500 MHz is common. However, the test of mobile WiMAX (Worldwide Interoperability for Microwave Access), WiBRO (Wireless Broadband), and LTE (Long Term Evolution) solutions require RF connectivity to 3900 MHz, while WLAN (wireless local area network) and fixed location WiMAX require RF connectivity to 6000 MHz.

As RF connectivity rates have increased, the use of RF power splitter/combiners such as the one disclosed in U.S. Pat. No. 5,668,510 has become less practical. Specifically, the performance of splitter/combiners employing coax cable, ferrite cores and coupled-wire technology begins to deteriorate around 2500 MHz, with these types of splitter/combiners becoming unusable above 3500 MHz. Degraded performance presents itself as one or more of loss of flat frequency response, increased insertion loss, and reduced isolation between ports.

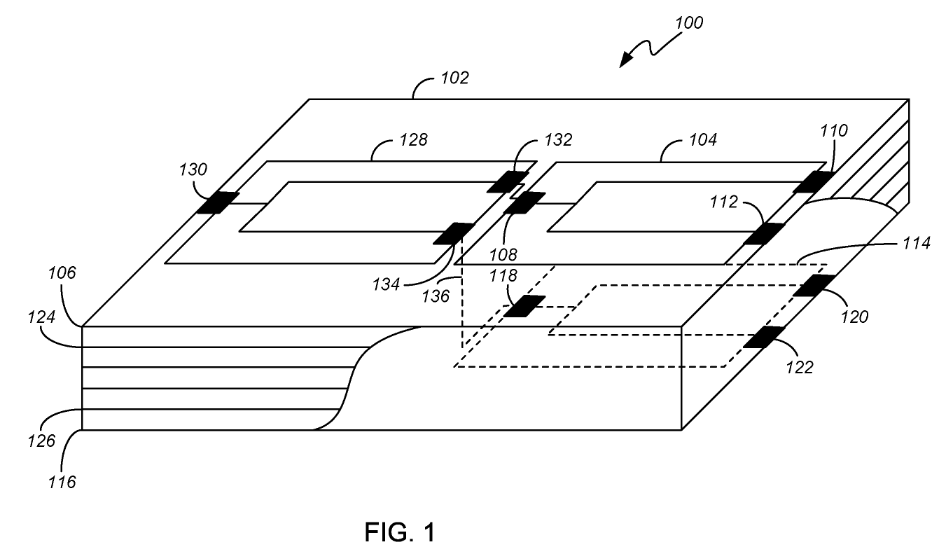

Given the above context, FIG. 1 illustrates a new RF power splitter/combiner 100. The new splitter/combiner 100 employs a multilayer printed circuit board (PCB) 102. A first power splitter/combiner section 104 is formed on a first layer 106 of the multilayer PCB 102 and has signal propagation traces coupling a first major port 108 to a first pair of minor ports 110, 112. A second power splitter/combiner section 114 is formed on a second layer 116 of the multilayer PCB 102 and has signal propagation traces coupling a second major port 118 to a second pair of minor ports 120, 122. At least one signal ground is formed on one or more layers 124, 126 of the multilayer PCB 102 intermediate the first layer 106 and the second layer 116. The at least one signal ground isolates the first power splitter/combiner section 104 from the second power splitter/combiner section 114. In addition, some degree of isolation between the splitter/combiner sections 104, 114 is provided by the thickness and composition of the multilayer PCB 102 itself.

In addition to providing good isolation between the first and second splitter/combiner sections 104, 114, forming the splitter/combiner sections 104, 114 on different layers 106, 116 of a multilayer PCB 102 allows the splitter/combiner sections 104, 114 to be stacked one on top of the other (if desired). In this manner, the first and second splitter/combiner sections 104, 114 can be implemented using half the surface area of a side-by-side implementation, with very little increase in PCB thickness.

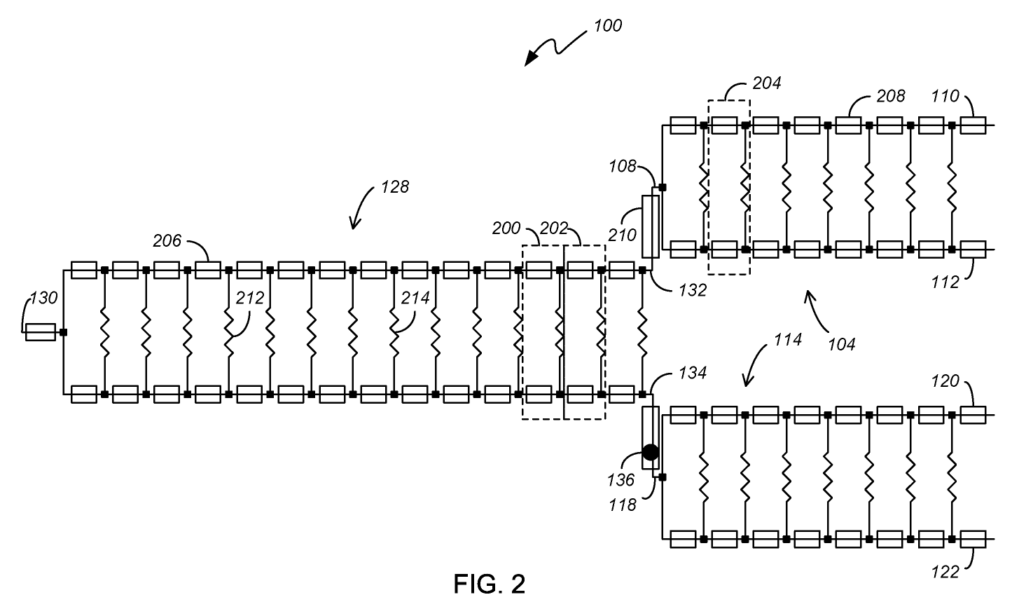

In some embodiments, each of the first and second splitter/combiner sections 104, 114 may be coupled to a third power splitter/combiner section 128, in cascaded fashion. That is, if a third splitter/combiner section 128 has signal propagation paths (e.g., traces) that couple a third major port 130 to a third pair of minor ports 132, 134, the minor ports of the third pair of minor ports 132, 134 may be respectively coupled to the major ports 108, 118 of the first and second splitter/combiner sections 104, 114. In some cases, the third splitter/combiner section 128 may be constructed separately from the multilayer PCB 102 on which the first and second splitter/combiner sections 104, 114 are formed. However, in other cases, the third splitter/combiner section 128 may be formed on a layer of the multilayer PCB 102. For example, in one embodiment, the third splitter/combiner section 128 may be formed on the same layer 106 as the first splitter/combiner section 104. The third splitter/combiner section 128 may then be connected to the major port 118 of the second splitter/combiner section 114 by means of a via 136 in the multilayer PCB 102. Also, the third splitter/combiner section 128 may then be connected to the major port 108 of the first splitter/combiner section 104 by means of a trace 210 (FIG. 2) on layer 106 of the multilayer PCB 102.

In some embodiments, one or more of the power splitter/combiner sections 104, 114, 128 may comprise one or more Wilkinson power divider sections. The Wilkinson power divider (or Wilkinson power divider section) was first proposed by Ernest J. Wilkinson in “An N-Way Hybrid Power Divider”, IRE Transactions on Microwave Theory and Techniques, pp. 116-118 (January 1960). The use of Wilkinson power divider sections to construct the various splitter/combiner sections 104, 114, 128 is advantageous because Wilkinson power divider sections are readily adaptable to PCB construction techniques. Wilkinson power dividers can be composed of sections of equal length transmission line lengths, periodically cross connected with balancing resistors. The artwork composing the equal length lines can be generated on a computer for PCB board fabrication. The balancing resistors for the Wilkinson power divider sections can also be placed on a PCB 102 using automated loading machinery, thereby eliminating hand loading and hand soldering of coax cable, ferrite cores, wires or other components when forming the splitter/combiner sections. Wilkinson power divider sections are also advantageous because they can be configured to provide a relatively flat frequency response up to 6000 MHz, with low insertion loss, and with good isolation between their minor ports.

By way of example, FIG. 2 provides a schematic of an RF power splitter/combiner 100 having first, second and third splitter/combiner sections 104, 114, 128, wherein each of the splitter/combiner sections 104, 114, 128 comprises multiple Wilkinson power divider sections 200, 202, 204. As shown, the signal propagation traces of the various Wilkinson sections may comprise microstrip transmission lines 206, 208, 210. The balancing resistors 212, 214 of the Wilkinson sections may, in some embodiments, comprise surface mount resistors.

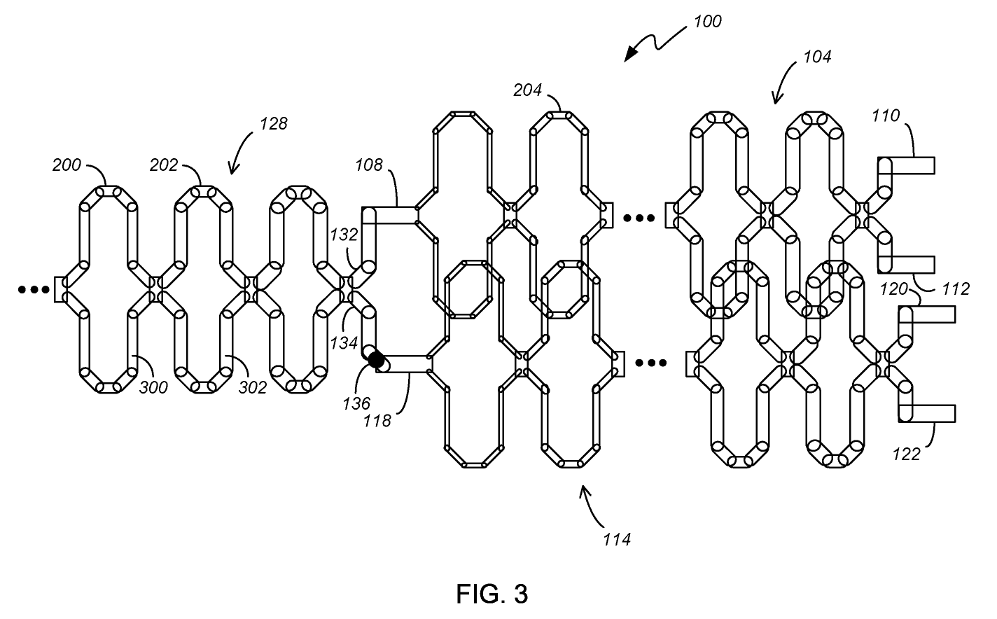

FIG. 3 illustrates exemplary portions of first and second layer artwork for the multilayer PCB 102, when the multilayer PCB 102 is used to implement the Wilkinson divider sections 200, 202, 204 shown in FIG. 2. As shown, the line widths of the signal traces 300, 302 in each successive Wilkinson divider section 200, 202 may be increased. In this manner, the multiple Wilkinson power divider sections 200, 202 in a particular splitter/combiner section 128 may be provided with stepped characteristic impedances. This can be useful because it enables matching of the characteristic impedances of the major and minor ports 130, 132, 134 of a splitter/combiner section 128 (e.g., the major and minor ports 108, 110, 112, 118, 120, 122, 130, 132, 134 of each splitter/combiner section 104, 114, 128 may be held to 50Ω).

Techniques that may be used when optimizing the Wilkinson power divider sections 200, 202, 204 for a particular application are disclosed, for example, by Seymour B. Cohn in “Optimum Design of Stepped Transmission-Line Transformers”, IRE Transactions—Microwave Theory and Techniques, pp. 16-21 (April 1955) and by Suhash C. Dutta Roy in “Low-Frequency Wide-Band Impedance Matching by Exponential Transmission Lines”, Proceedings of the EEE, Vol. 67, No. 8, pp. 1162-1163 (August 1979). In general, optimization techniques include varying the width and length of signal traces 300, 302, as well as the values of the balancing resistors 212, 214, to achieve a desired mix of port isolation, bandwidth, frequency response and insertion loss. Optimization may also include adding or deleting Wilkinson power divider sections 200, 202, 204. In general, the more Wilkinson power divider sections 200, 202, 204 used, the flatter the frequency response and the higher the bandwidth of a splitter/combiner section 104, 114, 128.

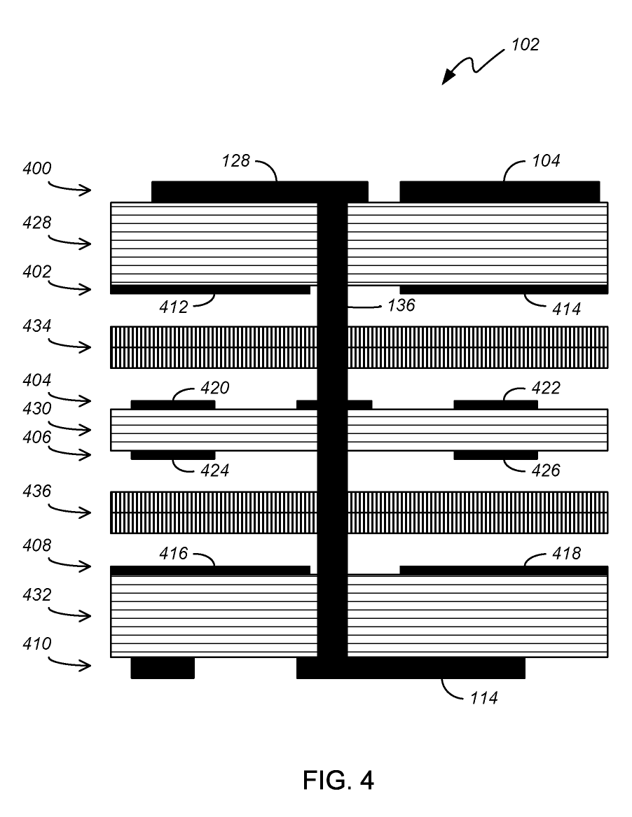

FIG. 4 illustrates, in cross-section, an exemplary exploded view of the multilayer PCB 102. As shown, the multilayer PCB 102 may be provided with six signal layers 400, 402, 404, 406, 408, 410, with the first, second and third splitter/combiner sections 104, 114, 128 being formed on the outer signal layers 400, 410. Microstrip grounds 412, 414, 416, 418 for the splitter/combiner sections 104, 114, 128 may be formed on a pair of inner signal layers 402, 408, one 402 of which is nearest the signal layer 400 on which the first and third splitter/combiner sections 104, 128 are formed, and one 408 of which is nearest the signal layer 410 on which the second splitter/combiner section 414 is formed. At least one additional signal layer 404, 406, intermediate the layers 402, 408 on which the microstrip grounds 412, 414, 416, 418 are formed, may be used to route various signal, power supply or control line signals 420, 422, 424, 426 of a device in which the RF power combiner/splitter 100 is incorporated. Of course, signal and ground traces other than those noted above may be routed in any of the signal layers 400, 402, 404, 406, 408, 410, with the caveat that, depending on its routing, any signal or ground routed within the multilayer PCB 102 has the potential to influence the operation of the RF power combiner/splitter 100.

The cross-section shown in FIG. 4 also illustrates the via 136 connecting the second and third splitter/combiner sections 114, 128. The impedance of the via 136 may be controlled, in part, by the position(s) of signal grounds 412, 414, 416, 418.

As further shown in FIG. 4, the multilayer PCB 102 may comprise three dielectric cores 428, 430, 432, each of which may be formed from one or more layers of material. After forming the microstrip grounds 412, 414, 416, 418 and the signal traces 420, 422, 424, 426 on the inner surfaces of the dielectric cores 428, 430, 432, the dielectric cores 428, 430, 432 may be bonded to one another in various ways, and in some embodiments are bonded to one another by layers of prepreg 434, 436.

By way of example, the multilayer PCB 102 may be constructed using Rogers 4350B multilayer PCB technology (available from Rogers Corporation, based in Rogers, Conn.).

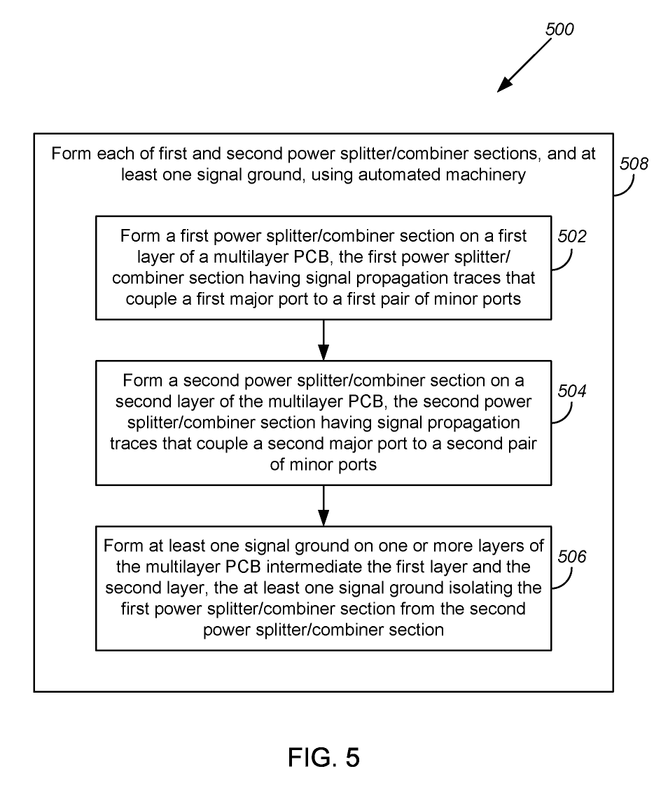

FIG. 5 illustrates an exemplary method 500 of forming an RF power splitter/combiner. The steps of the method 500 include 1) forming a first power splitter/combiner section on a first layer of a multilayer PCB, the first power splitter/combiner section having signal propagation traces that couple a first major port to a first pair of minor ports (see block 502); 2) forming a second power splitter/combiner section on a second layer of the multilayer PCB, the second power splitter/combiner section having signal propagation traces that couple a second major port to a second pair of minor ports (see block 504); 3) forming at least one signal ground on one or more layers of the multilayer PCB intermediate the first layer and the second layer, the at least one signal ground isolating the first power splitter/combiner section from the second power splitter/combiner section (see block 506); and 4) forming each or the first and second power splitter/combiner sections, and at least one signal ground, using automated machinery (see block 508). Although the steps 502, 504, 506, 508 of the method 500 are shown in a particular arrangement, one of ordinary skill in the art will understand that the steps 502, 504, 506, 508 may be performed in various orders.

The method 500 is useful, in one respect, in that it eliminates hand loading and hand soldering when forming the first and second power divider sections and at least one signal ground. Machine based fabrication methods also tend to lead to lower cost and more repeatable results (e.g., smaller manufacturing tolerances, higher yield, and improved reliability). Machine based fabrication also enables good matching between the first and second splitter/combiner sections, as well as good control of characteristic impedances.

What is claimed is:

1. A radio frequency (RF) power splitter/combiner, comprising:
a multilayer printed circuit board (PCB);
a first power splitter/combiner section formed on a first layer of the multilayer PCB, having signal propagation traces that couple a first major port to a first pair of minor ports;
a second power splitter/combiner section formed on a second layer of the multilayer PCB, having signal propagation traces that couple a second major port to a second pair of minor ports; and
at least one signal ground formed on one or more layers of the multilayer PCB intermediate the first layer and the second layer, the at least one signal ground isolating the first power splitter/combiner section from the second power splitter/combiner section.

2. The RF power splitter/combiner of claim 1, wherein each of the first and second power splitter/combiner sections comprises multiple Wilkinson power divider sections.

3. The RF power splitter/combiner of claim 2, wherein, for each of the first and second power splitter/combiner sections, the multiple Wilkinson power divider sections have stepped characteristic impedances.

4. The RF power splitter/combiner of claim 3, wherein each of the major and minor ports has the same characteristic impedance.

5. The RF power splitter/combiner of claim 2, wherein each of the Wilkinson Power divider sections comprises a surface mount resistor.

6. The RF power splitter/combiner of claim 1, wherein the first and second power splitter/combiner sections are matched.

7. The RF power splitter/combiner of claim 1, further comprising a third power splitter/combiner section formed on a layer of the multilayer PCB, having signal propagation traces that couple a third major port to a third pair of minor ports, wherein the minor ports in the third pair of minor ports are respectively coupled to the major ports of the first and second power splitter/combiner sections.

8. The RF power splitter/combiner of claim 7, wherein the third power splitter/combiner section is formed on the first layer of the multilayer PCB and connected to the major port of the second power splitter/combiner section by a via in the multilayer PCB.

9. The RF power splitter/combiner of claim 7, wherein the via has a controlled impedance, controlled in part by a position of the at least one signal ground with respect to the via.

10. The RF power splitter/combiner of claim 8, wherein each of the first, second and third power splitter/combiner sections comprises multiple Wilkinson power divider sections.

11. The RF power splitter/combiner of claim 10, wherein, for each of the first, second and third power splitter/combiner sections, the multiple Wilkinson power divider sections have stepped characteristic impedances.

12. The RF power splitter/combiner of claim 11, wherein each of the major and minor ports has the same characteristic impedance.

13. The RF power splitter/combiner of claim 7, wherein the signal propagation traces of the first, second and third power splitter/combiner sections comprise microstrip transmission lines.

14. The RF power splitter/combiner of claim 1, wherein the one or more layers on which the at least one signal ground is formed comprises third and fourth layers of the multilayer PCB, the third layer being a signal layer nearest the first layer, and the fourth layer being a signal layer nearest the second layer.

15. The RF power splitter/combiner of claim 14, wherein the multilayer PCB further comprises at least one additional signal layer intermediate the third and fourth layers.

16. A method of forming a radio frequency (RF) power splitter/combiner, comprising:
forming a first power splitter/combiner section on a first layer of a multilayer PCB, the first power splitter/combiner section having signal propagation traces that couple a first major port to a first pair of minor ports;
forming a second power splitter/combiner section on a second layer of the multilayer PCB, the second power splitter/combiner section having signal propagation traces that couple a second major port to a second pair of minor ports;
forming at least one signal ground on one or more layers of the multilayer PCB intermediate the first layer and the second layer, the at least one signal ground isolating the first power splitter/combiner section from the second power splitter/combiner section; and
forming each of the first and second power splitter/combiner sections, and at least one signal ground, using automated machinery, thereby eliminating hand loading and hand soldering when forming the first and second power divider sections and at least one signal ground.

17. The method of claim 16, further comprising, forming each of the first and second power splitter/combiner sections using multiple Wilkinson power divider sections.

18. The method of claim 16, further comprising:
forming a third power splitter/combiner section formed on a layer of the multilayer PCB, the third power splitter/combiner section having signal propagation traces that couple a third major port to a third pair of minor ports; and
respectively coupling the minor ports in the third pair of minor ports to the major ports of the first and second power splitter/combiner sections.

19. The method of claim 18, further comprising:
forming the third power splitter/combiner section on the first layer of the multilayer PCB; and
connecting the third power splitter/combiner to the major port of the second power splitter/combiner section by forming a via in the multilayer PCB.

20. The method of claim 19, further comprising, providing the via with a controlled impedance by, in part, controlling a position of the at least one signal ground with respect to the via.

21. The method of claim 19, further comprising, forming each of the first, second and third power splitter/combiner sections using multiple Wilkinson power divider sections.
